(19) United States
(12) Patent Application Publication
(10) Pub. No.: US 2025/0196939 A1
(43) Pub. Date: Jun. 19, 2025

(54) Truck Tailgate Workbench Device

(71) Applicant: Gary Gonzalez, Liberty Hill, TX (US)

(72) Inventor: Gary Gonzalez, Liberty Hill, TX (US)

(21) Appl. No.: 18/744,778

(22) Filed: Jun. 17, 2024

Related U.S. Application Data
(60) Provisional application No. 63/611,276, filed on Dec. 18, 2023.

(51) Int. Cl. B62D 33/027; B62D 33/03

(52) U.S. Cl. CPC B62D 33/0273; B62D 33/03

(57) ABSTRACT

A truck tailgate workbench device is disclosed, which is a multi-functional workbench surface designed to secure to a truck tailgate. The truck tailgate workbench device comprises a body component that is configured in a rectangular shape to match the truck tailgate. The body component comprises foldable legs to support the device next to the truck tailgate or as a standalone table. The top of the body component comprises a foldable work surface that can be secured to the truck tailgate or be folded over on itself for the standalone table. The foldable work surface comprises at least one measurement imprint. The body component also comprises at least one power outlet hub and at least one compartment for tools and materials. The device can also be folded flat for storage.

### CROSS-REFERENCE TO RELATED APPLICATION

The present application claims priority to, and the benefit of, U.S. Provisional Application No. 63/611,276, which was filed on Dec. 18, 2023, and is incorporated herein by reference in its entirety.

### FIELD OF THE INVENTION

The present invention relates generally to the field of truck tailgate workbench devices. More specifically, the present invention relates to a device that adds useability to a truck tailgate by providing a detachable foldable workbench extension for a truck tailgate. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in truck tailgate workbench devices. Generally, people desire more usability out of their truck tailgate. Further, carrying toolboxes, folding tables, and cords is inefficient and inconvenient for small-scale outdoor projects. Users needing to make bike repairs, perform outdoor equipment maintenance, construction projects, painting, gardening, or small engine repair, etc., would require a workspace that is highly portable and mobile for outdoor projects, when needed.

Furthermore, the tailgate of a pickup truck has been found to be useful as a workstation. Such workstations can be created by opening the tailgate into a flat position and using the tailgate and truck bed as a support surface for performing various tasks. However, in some instances, toolboxes or storage compartments would be beneficial to the task at hand. Further, most tailgates do not come equipped with storage compartments or toolboxes. Additionally, tailgates have limited surface from which to perform work. Users must expend additional effort and time to haul out toolboxes, tables, small tools, etc., for outdoor projects.

Accordingly, there is a demand for an improved truck tailgate workbench device that provides a lightweight, durable, and detachable multi-functional workbench surface designed to attach to a truck tailgate. More particularly, there is a demand for a truck tailgate workbench device that also compactly folds flat with its legs nested inside for storage, when not in use.

Therefore, there exists a long-felt need in the art for a truck tailgate workbench device that adds usability to a truck tailgate. There is also a long-felt need in the art for a truck tailgate workbench device that provides a foldable workbench extension for a truck tailgate. Further, there is a long-felt need in the art for a truck tailgate workbench device that can be a standalone table or can be extended with the tailgate for additional space. Moreover, there is a long-felt need in the art for a device that comprises a power outlet hub and small tool and material storage compartments. Further, there is a long-felt need in the art for a truck tailgate workbench device that provides a work surface with imprinted measurement edges. Finally, there is a long-felt need in the art for a truck tailgate workbench device that comprises foldable legs.

The subject matter disclosed and claimed herein, in one embodiment thereof, comprises a truck tailgate workbench device. The device is a multi-functional workbench surface designed to secure to a truck tailgate. The truck tailgate workbench device comprises a body component that is configured in a rectangular shape to match the truck tailgate. The body component comprises foldable legs to support the device next to the truck tailgate or as a standalone table. The top of the body component comprises a foldable work surface that can be secured to the truck tailgate or be detached and folded outward for the standalone table. The foldable work surface comprises at least one measurement imprint. The body component also comprises at least one power outlet hub with cord and at least one compartment for tools and materials. The device can also be folded flat for storage.

In this manner, the truck tailgate workbench device of the present invention accomplishes all of the foregoing objectives and provides users with a foldable workbench extension device for a truck tailgate. The device can be an extension of the tailgate or a standalone table. The device comprises foldable legs for storage.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a truck tailgate workbench device. The device is a multi-functional workbench surface designed to secure to a truck tailgate. The truck tailgate workbench device comprises a body component that is configured in a rectangular shape to match the truck tailgate. The body component comprises foldable legs to support the device next to the truck tailgate or as a standalone table. The top of the body component comprises a foldable work surface that can be secured to the truck tailgate or be folded outward for the standalone table.

In one embodiment, the truck tailgate workbench device provides a workbench assembly that is mounted to a tailgate of a vehicle or can be a standalone table. For storage purposes, the device can be folded up compact for storage with the legs secured within the body component and secured to the vehicle tailgate. As the tailgate opens and closes, the truck tailgate workbench device remains compact and mounted to the tailgate, until needed for use.

In one embodiment, the truck tailgate workbench device is utilized with the tailgate of a vehicle, such as a pickup truck. Although a pick-up truck is shown, it is contemplated for the present invention to be connected to any vehicle having a pivoting tailgate that can be moved between a substantially vertically-extending closed position and a substantially horizontally-extending open position. Hereinafter, any statement about the present invention relating to use in a pick-up truck should also be considered applicable to other vehicles (not shown) with pivoting tailgates, unless otherwise specifically mentioned. Further, the vehicle includes a truck bed that is surrounded by opposing first and second sides, a third side, a bed floor, and a tailgate. The tailgate is configured to pivot about hinges (not shown) between an open position and a closed position. The truck bed is open to its surroundings from above, although in alternate embodiments, the truck bed may not be open to its surroundings from above, such as when a camper shell or other closure is mounted to the truck bed. The vehicle also includes a rear bumper and a plurality of wheels or tires.

In one embodiment, the truck tailgate workbench device is mounted to the tailgate. The means for attaching the device can vary depending on the application for using the truck tailgate workbench device. In one embodiment, the device can be screwed into the tailgate with screws, bolts, or other fasteners/hardware, etc. In other embodiments, the device can be secured with adhesive, rope, cords, wire, clamps, or any other fastening means. Typically, attachment fasteners/hardware are recessed for a flush work surface for the user.

In one embodiment, when the truck tailgate workbench device is not in use, the device is compacted for storage and can be secured to the tailgate for ease in transportation or detached from the tailgate and stored in the truck bed or other suitable place. Thus, the truck tailgate workbench device is coupled to the tailgate such that, as the tailgate is pivoted or moved from a substantially closed position to a substantially open position, and vice versa, the device remains securely coupled to the tailgate and also pivots with the tailgate. Accordingly, the length and width of the body component and work surface of the device is at least slightly less than the corresponding length and width of the tailgate in order to prevent one or more edges of the device closest to the truck bed from interfering with the opening and closing of the tailgate. However, it is advantageous to have the cross-sectional area of the foldable work surface to be as great as possible to facilitate a large working surface secured to the body component for a user to complete any desired task.

In one embodiment, the truck tailgate workbench device comprises a body component and a foldable work surface secured to the body component. The body component is configured in a rectangular shape to match the configuration of the tailgate. The body component measures approximately 19″×58″×6″, but can be any suitable shape and size as is known in the art, depending on the shape and size of the truck tailgate being used with the device. Further, the body component comprises opposing side edges, opposing front and rear edges, a top surface, and a bottom surface. Generally, the body component has a planar upper surface and is placed into a substantially horizontally-extending orientation when the tailgate is extended. In addition, the size, perimeter configuration, and thickness dimension of the body component and the foldable work surface may vary from that shown in the figures.

In one embodiment, the bottom surface of the body component comprises a plurality of foldable legs. Specifically, the foldable legs are secured to the bottom surface via any suitable securing means as is known in the art. Typically, a foldable leg is positioned in a corner of the bottom surface but can be positioned in any suitable position as is known in the art. The legs are foldable and able to be collapsed for storage. Typically, the legs are folded then secured within the bottom surface of the body component for storage. In one embodiment, the legs are secured to the corners of the bottom surface via a lock-out folding leg mechanism. This mechanism allows the legs to be secured at the corners of the bottom surface and then hinged downward and locked for use. For storage, the legs are unlocked and folded up into the bottom surface. In this embodiment, the legs would also be telescoping, allowing the legs to extend and retract, as needed. Thus, the legs would be retracted and unlocked, then folded, such that they nest within the bottom surface of the body component for storage.

In one embodiment, an additional set of legs can be included and secured to the bottom surface of the body component. This additional set of legs would be utilized when the device is being used as a standalone table with the work surface extended. The legs would be secured to the corners of the extended work surface for support, as needed. After use, the legs would be retracted and removed, then stored in the bottom surface of the body component in a nested configuration.

In one embodiment, the base component comprises a foldable work surface secured to it. The foldable work surface comprises two rectangular panel components that are secured at their sides via several hinges. In one embodiment, the hinges are lock-out, bi-fold hinges, and are recessed, such that they are flush with the work surface. Typically, the panel components each comprise a top surface, a bottom surface, opposing front and back sides, and opposing right and left edges. The panel components are secured together at their opposing front and back sides. The hinges, allow the panel components to be extended for a large work surface or folded in for a smaller, more compact work surface. Further, the first panel component is joined by hinges that allow the first panel component to be rotatable in a full 180 degree range relative to the second panel component.

In one embodiment, the panel components comprise a strong and durable material, such as a rhino lining surface or other suitable materials, as is known in the art. Further, the work surface panel components comprise at least one measurement imprint. Generally, the work surface panel components comprise three measurement imprints, with one imprinted on each outside edge. In another embodiment, the work surface panel components comprise at least one panel with a rhino lining and measurement imprints on both top and bottom surfaces, such that when the panel components are folded at the hinges on top of each other, the exposed bottom surface can be utilized as a work surface in the standalone table configuration.

In one embodiment, the body component comprises at least one power outlet hub and detachable cord(s). The power outlet hub is typically integrated into the body component side edges to allow for flat folding of the work surface panel components and to provide a maximum work surface area. The cord or power cable can be detached and then nested and secured within the bottom surface of the body component for storage and to maximize the available space.

In one embodiment, the body component comprises at least one storage compartment for tools and materials. Typically, the storage compartments are integrated into the body component's front edge but can be integrated into any suitable position on the body component. The storage compartments can be drawers, slots, openings, etc. The compartments can also have lids if needed. The storage compartments can be any suitable size and shape as is known in the art and are typically configured to retain small tools and other materials. For example, the storage compartments can be used to store loose items such as hammers, screwdrivers, wrenches, power tools, etc.

In one embodiment, the truck tailgate workbench device can be configured as an extension of the truck tailgate or as a standalone table. In the embodiment where the device is an extension of the tailgate, the body component is removed from the tailgate and the legs are extended and locked into place at each corner. The body component is then positioned next to the extended tailgate and the foldable work surface is unfolded at its hinges, such that one of the work surface panel components rests on top of the extended tailgate. The work surface panel component is then secured to the extended tailgate via bolts, screws, or other hardware. Typically, attachment fasteners/hardware are recessed for a flush work surface for the user.

In another embodiment, the truck tailgate workbench device can be configured as a standalone table. In this embodiment, the work surface panel components are unsecured from the extended tailgate and folded onto themselves forming a smaller work surface area, but one that still has the durable rhino lining and measurement imprints for use. If a large work surface area is needed, a user can unfold the work surface panel components and remove the additional set of legs from the bottom surface of the body component and attach these legs to the bottom corners of the extended work surface panel component, to provide a full-size standalone configuration for the device.

In one embodiment, the body component is manufactured from any suitable materials, such as wood, plastic, steel, or any other material desired by one of skill in the art. Further, the foldable work surface is manufactured from a durable material or comprises a coating of a durable material, such as a rhino lining, etc.

In one embodiment, the body component can comprise additional accessories, depending on the needs and/or wants of a user, such as a light source (i.e., a light-emitting diode (“LED”), and batteries), a pencil holder, receptacles for holding drinks, and/or a magnetic tray for holding screws, nails, drill bits, etc.

In one embodiment, the truck tailgate workbench device can be offered as an OEM feature on newly manufactured pickup trucks or can be available as an after-market addition, depending on the wants and/or needs of a user.

In yet another embodiment, the truck tailgate workbench device comprises a plurality of indicia.

In yet another embodiment, a method of adding useability to a truck tailgate is disclosed. The method includes the steps of providing a truck tailgate workbench device with a body component and a foldable work surface and foldable legs. The method comprises securing the foldable work surface to an extended truck tailgate. The method also comprises extending the foldable legs to support the body component. Further, the method comprises utilizing the device as a workbench with a power hub and storage compartments. The method also comprises detaching the foldable work surface from the truck tailgate and using the device as a standalone table. Finally, the method comprises compacting the device and folding the legs for storage.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-C illustrate a perspective view of one embodiment of the truck tailgate workbench device of the present invention showing the device as an extension of a tailgate, as a standalone table, and collapsed for storage in accordance with the disclosed architecture;

FIGS. 2A-C illustrate a perspective view of one embodiment of the truck tailgate workbench device of the present invention showing the device as a standalone table with storage compartments in accordance with the disclosed architecture;

FIGS. 3A-B illustrate a perspective view of one embodiment of the truck tailgate workbench device of the present invention showing the device folded flat for storage in accordance with the disclosed architecture;

FIGS. 4A-B illustrate a perspective view of one embodiment of the truck tailgate workbench device of the present invention showing the device as an extension of the tailgate and as a standalone table in accordance with the disclosed architecture;

FIGS. 5A-D illustrate a perspective view of the various embodiments of the truck tailgate workbench device of the present invention in accordance with the disclosed architecture; and

FIG. 6 illustrates a flowchart showing the method of adding useability to a truck tailgate in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a truck tailgate workbench device that adds usability to a truck tailgate. There is also a long-felt need in the art for a truck tailgate workbench device that provides a foldable workbench extension for a truck tailgate. Further, there is a long-felt need in the art for a truck tailgate workbench device that can be a standalone table or can be extended with the tailgate for additional space. Moreover, there is a long-felt need in the art for a device that comprises a power outlet hub and small tool and material storage compartments. Further, there is a long-felt need in the art for a truck tailgate workbench device that provides a work surface with imprinted measurement edges. Finally, there is a long-felt need in the art for a truck tailgate workbench device that comprises foldable legs.

The present invention, in one exemplary embodiment, is a novel truck tailgate workbench device. The truck tailgate workbench device comprises a body component that is configured in a rectangular shape to match the truck tailgate. The body component comprises foldable legs to support the device next to the truck tailgate or as a standalone table. The top of the body component comprises a foldable work surface that can be secured to the truck tailgate or be folded outward for the standalone table. The foldable work surface comprises at least one measurement imprint. The body component also comprises at least one power outlet hub with cord and at least one compartment for tools and materials. The device can also be folded flat for storage. The present invention also includes a novel method of adding useability to a truck tailgate. The method includes the steps of providing a truck tailgate workbench device with a body component and a foldable work surface and foldable legs. The method comprises securing the foldable work surface to an extended truck tailgate. The method also comprises extending the foldable legs to support the body component. Further, the method comprises utilizing the device as a workbench with a power hub and storage compartments. The method also comprises detaching the foldable work surface from the truck tailgate and using the device as a standalone table. Finally, the method comprises compacting the device and folding the legs for storage.

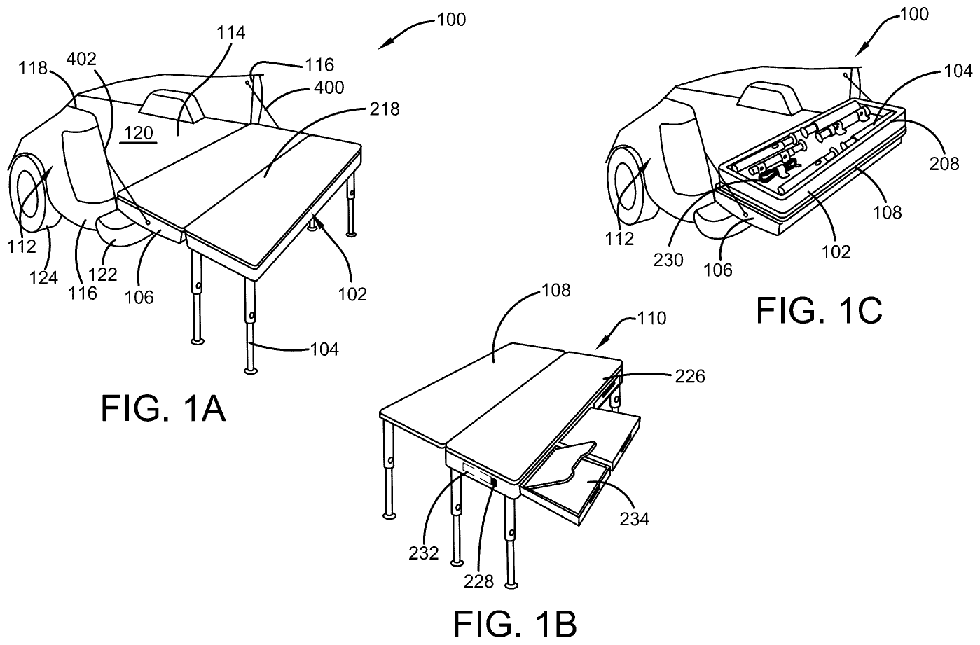

Referring initially to the drawings, FIGS. 1A-C illustrate a perspective view of one embodiment of the truck tailgate workbench device 100 of the present invention. In the present embodiment, the truck tailgate workbench device 100 is an improved truck tailgate workbench device 100 that provides a user with a foldable workbench extension for a truck tailgate 106. Specifically, the truck tailgate workbench device 100 comprises a body component 102 that is configured in a rectangular shape to match the truck tailgate 106. The body component 102 comprises foldable legs 104 to support the device 100 next to the truck tailgate 106 or as a standalone table 110. The top of the body component 102 comprises a foldable work surface 108 that can be secured to the truck tailgate 106 or be folded over on itself for the standalone table 110.

Generally, the truck tailgate workbench device 100 provides a workbench assembly that is mounted to a tailgate 106 of a vehicle 112 or can be a standalone table 110. For storage purposes, the device 100 can be folded up compact for storage with the legs 104 secured within the body component 102 and secured to the vehicle tailgate 106 or positioned in the truck bed 114 or other suitable place for storage. As the tailgate 106 opens and closes, the truck tailgate workbench device 100 remains compact and mounted to the tailgate 106, until needed for use.

Furthermore, the truck tailgate workbench device 100 is utilized with the tailgate 106 of a vehicle 112, such as a pickup truck. Although a pick-up truck is shown, it is contemplated for the present invention to be connected to any vehicle 112 having a pivoting tailgate 106 that can be moved between a substantially vertically-extending closed position and a substantially horizontally-extending open position. Hereinafter, any statement about the present invention relating to use in a pick-up truck 112 should also be considered applicable to other vehicles 112 (not shown) with pivoting tailgates 106, unless otherwise specifically mentioned. Further, the vehicle 112 includes a truck bed 114 that is surrounded by opposing first and second sides 116, a third side 118, a bed floor 120, and a tailgate 106. The tailgate 106 is configured to pivot about hinges (not shown) between an open position and a closed position. The truck bed 114 is open to its surroundings from above, although in alternate embodiments, the truck bed 114 may not be open to its surroundings from above, such as when a camper shell or other closure is mounted to the truck bed 114. The vehicle 112 also includes a rear bumper 122 and a plurality of wheels or tires 124.

In transport, the truck tailgate workbench device 100 is mounted to the tailgate 106. The means for attaching the device 100 can vary depending on the application for using the truck tailgate workbench device 100. In one embodiment, the device 100 can be screwed into the tailgate 106 with screws, bolts, or other fasteners/hardware, etc. In other embodiments, the device 100 can be secured with adhesive, rope, cords, wire, clamps, or any other fastening means. Typically, attachment fasteners/hardware are recessed for a flush work surface for the user.

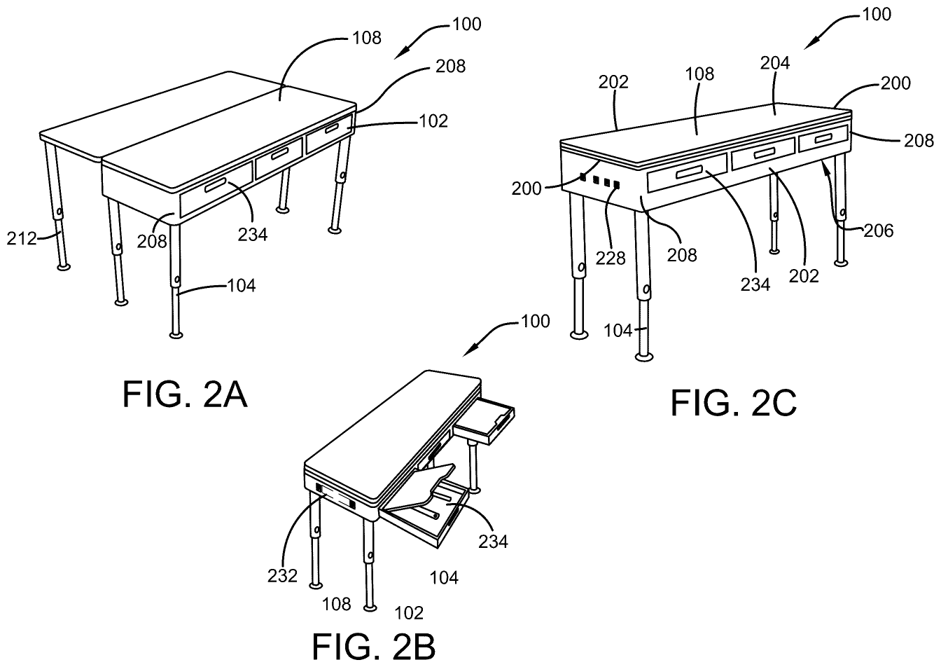

As shown in FIGS. 2A-C, the truck tailgate workbench device 100 comprises a body component 102 and a foldable work surface 108 secured to the body component 102. The body component 102 is configured in a rectangular shape to match the configuration of the tailgate 106. The body component 102 measures approximately 19″×58″×6″, but can be any suitable shape and size as is known in the art, depending on the shape and size of the truck tailgate 106 being used with the device 100. Further, the body component 102 comprises opposing side edges 200, opposing front and rear edges 202, a top surface 204, and a bottom surface 206. Generally, the body component 102 has a planar upper surface and is placed into a substantially horizontally-extending orientation when the tailgate 106 is extended. In addition, the size, perimeter configuration, and thickness dimension of the body component 102 and the foldable work surface 108 may vary from that shown in the figures.

Furthermore, the bottom surface 206 of the body component 102 comprises a plurality of foldable legs 104. Specifically, the foldable legs 104 are secured to the bottom surface 206 via any suitable securing means as is known in the art. Typically, a foldable leg 104 is positioned in a corner 208 of the bottom surface 206 but can be positioned in any suitable position as is known in the art. The legs 104 are foldable and able to be collapsed for storage. Typically, the legs 104 are folded then secured within the bottom surface 206 of the body component 102 for storage. In one embodiment, the legs 104 are secured to the corners 208 of the bottom surface 206 via a lock-out folding leg mechanism 210. This mechanism 210 allows the legs 104 to be secured at the corners 208 of the bottom surface 206 and then hinged downward and locked for use. For storage, the legs 104 are unlocked and folded up into the bottom surface 206. In this embodiment, the legs 104 would also be telescoping, allowing the legs 104 to extend and retract, as needed. Thus, the legs 104 would be retracted and unlocked, then folded, such that they nest within the bottom surface 206 of the body component 102 for storage.

In one embodiment, an additional set of legs 212 can be included and secured to the bottom surface 206 of the body component 102. This additional set of legs 212 would be utilized when the device 100 is being used as a standalone table 110 with the work surface 108 extended. The legs 212 would be secured to the corners 208 of the extended work surface 108 for support, as needed. After use, the legs 212 would be retracted and removed, then stored in the bottom surface 206 of the body component 102 in a nested configuration.

Additionally, the base component 102 comprises a foldable work surface 108 secured to it. The foldable work surface 108 comprises two rectangular panel components 214 that are secured at their sides 216 via several hinges 218. In one embodiment, the hinges 218 are lock-out, bi-fold hinges and are recessed, such that they are flush with the work surface 108. Typically, the panel components 214 each comprise a top surface 220, a bottom surface 222, opposing front and back sides 216, and opposing right and left edges 224. The panel components 214 are secured together at their opposing front and back sides 216. The hinges 218, allow the panel components 214 to be extended for a large work surface or folded in for a smaller, more compact work surface. Further, the first panel component 214 is joined by hinges 218 that allow the first panel component 214 to be rotatable in a full 180 degree range relative to the second panel component 214.

In one embodiment, the panel components 214 comprise a strong and durable material, such as a rhino lining surface or other suitable materials, as is known in the art. Further, the work surface panel components 214 comprise at least one measurement imprint 226. Generally, the work surface panel components 214 comprise three measurement imprints 226, with one imprinted on each outside edge 224. In another embodiment, the work surface panel components 214 comprise at least one panel with a rhino lining and measurement imprints 226 on both top and bottom surfaces 220, 222, such that when the panel components 214 are folded at the hinges 218 on top of each other, the exposed bottom surface 222 can be utilized as a work surface in the standalone table configuration 110.

Further, in another embodiment, the body component 102 comprises at least one power outlet hub 228 and detachable cord(s) 230. The power outlet hub 228 is typically integrated into the body component side edges 200 to allow for flat folding of the work surface panel components 214 and to provide a maximum work surface area. The cord 230 or power cable can be detached and then nested and secured within the bottom surface 206 of the body component 102 for storage and to maximize the available space.

Furthermore, the body component 102 comprises at least one storage compartment 234 for tools and materials. Typically, the storage compartments 234 are integrated into the body component front edge 202 but can be integrated in any suitable position on the body component 102. The storage compartments 234 can be drawers, slots, openings, etc. The compartments 234 can also have lids, if needed. The storage compartments 234 can be any suitable size and shape as is known in the art and are typically configured to retain small tools and other materials. For example, the storage compartments 234 can be used to store loose items such as hammers, screwdrivers, wrenches, power tools, etc.

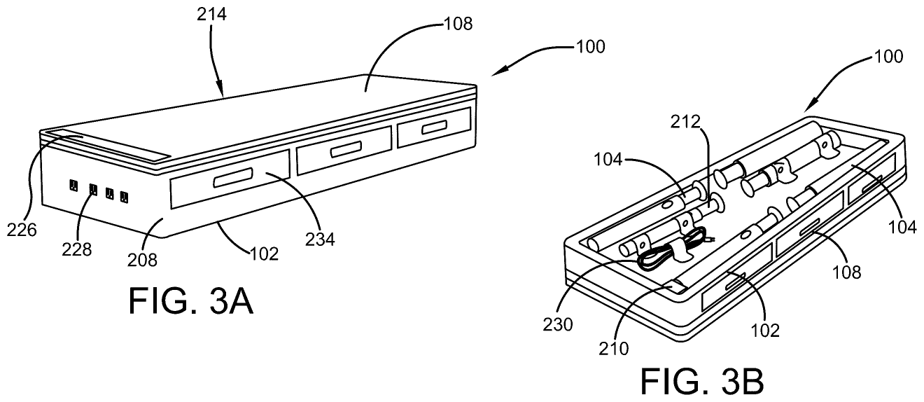

As shown in FIGS. 3A-B, when the truck tailgate workbench device 100 is not in use, the device 100 is compacted for storage and secured to the tailgate 106 for ease in transportation. Thus, the truck tailgate workbench device 100 is coupled to the tailgate 106 such that, as the tailgate 106 is pivoted or moved from a substantially closed position to a substantially open position, and vice versa, the device 100 remains securely coupled to the tailgate 106 and also pivots with the tailgate 106. Accordingly, the length and width of the body component 102 and work surface 108 of the device 100 is at least slightly less than the corresponding length and width of the tailgate 106 in order to prevent one or more edges of the device 100 closest to the truck bed 114 from interfering with the opening and closing of the tailgate 106. However, it is advantageous to have the cross-sectional area of the foldable work surface 108 to be as great as possible to facilitate a large working surface secured to the body component 102 for a user to complete any desired task.

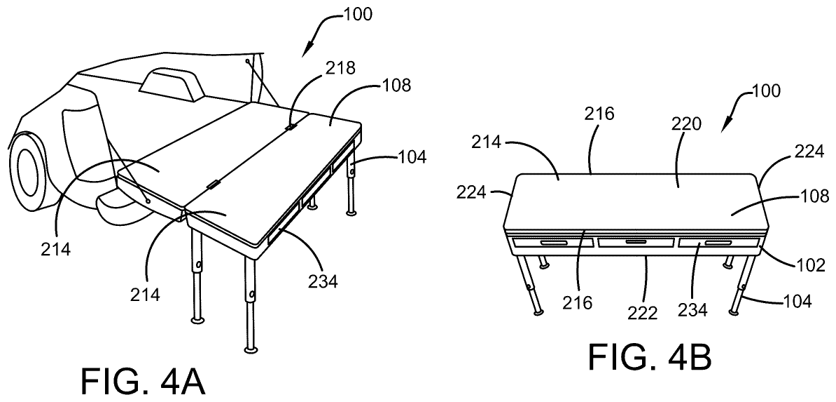

As shown in FIGS. 4A-B, the truck tailgate workbench device 100 can be configured as an extension of the truck tailgate 106 or as a standalone table 110. In the embodiment where the device 100 is an extension of the tailgate 106, the body component 102 is removed from the tailgate 106, and the legs 104 are extended and locked into place at each corner 208. The body component 102 is then positioned next to the extended tailgate 106 and the foldable work surface 108 is unfolded at its hinges 218, such that one of the work surface panel components 214 rests on top of the extended tailgate 106. The work surface panel component 214 is then secured to the extended tailgate 106 via bolts, screws, or other hardware. Typically, attachment fasteners/hardware are recessed for a flush work surface for the user.

In another embodiment, the truck tailgate workbench device 100 can be configured as a standalone table 110. In this embodiment, the work surface panel components 214 are unsecured from the extended tailgate 106 and folded onto themselves forming a smaller work surface area, but one that still has the durable rhino lining and measurement imprints 226 for use. If a large work surface area is needed, a user can unfold the work surface panel components 214 and remove the additional set of legs 212 from the bottom surface 206 of the body component 102 and attach these legs 212 to the bottom corners 208 of the extended work surface panel component 214, to provide a full-size standalone configuration for the device 100.

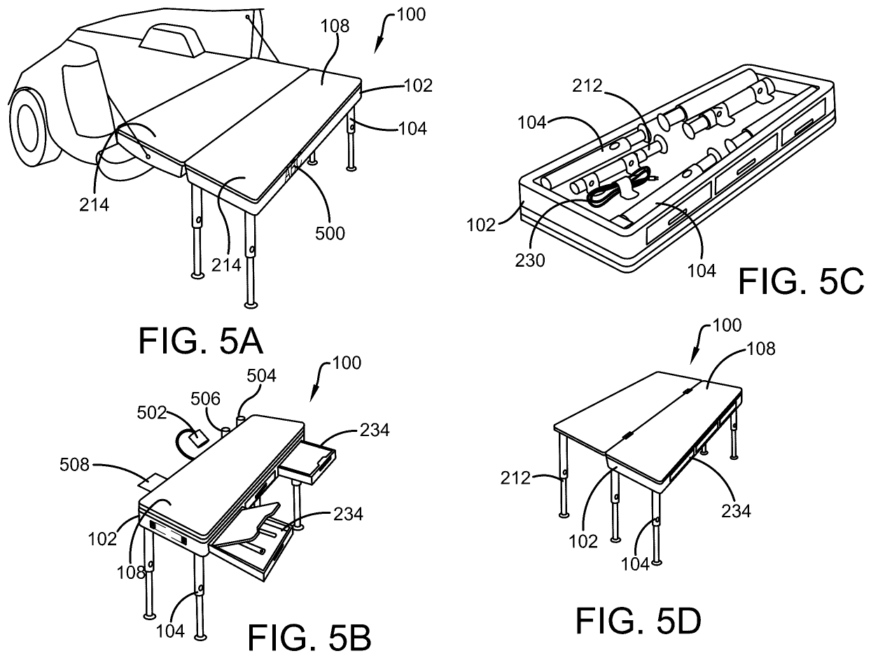

As shown in FIGS. 5A-D, the body component 102 is manufactured from any suitable materials, such as wood, plastic, steel, or any other material desired by one of skill in the art. Further, the foldable work surface 108 is manufactured from a durable material or comprises a coating of a durable material, such as a rhino lining, etc.

In one embodiment, the body component 102 can comprise additional accessories, depending on the needs and/or wants of a user, such as a light source 502 (i.e., a light-emitting diode (“LED”) and batteries), a pencil holder 504, receptacles for holding drinks 506, and/or a magnetic tray 508 for holding screws, nails, drill bits, etc.

In one embodiment, the truck tailgate workbench device 100 can be offered as an OEM feature on newly manufactured pickup trucks 112 or can be available as an after-market addition, depending on the wants and/or needs of a user.

In yet another embodiment, the truck tailgate workbench device comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be tailgate, truck, or brand related.

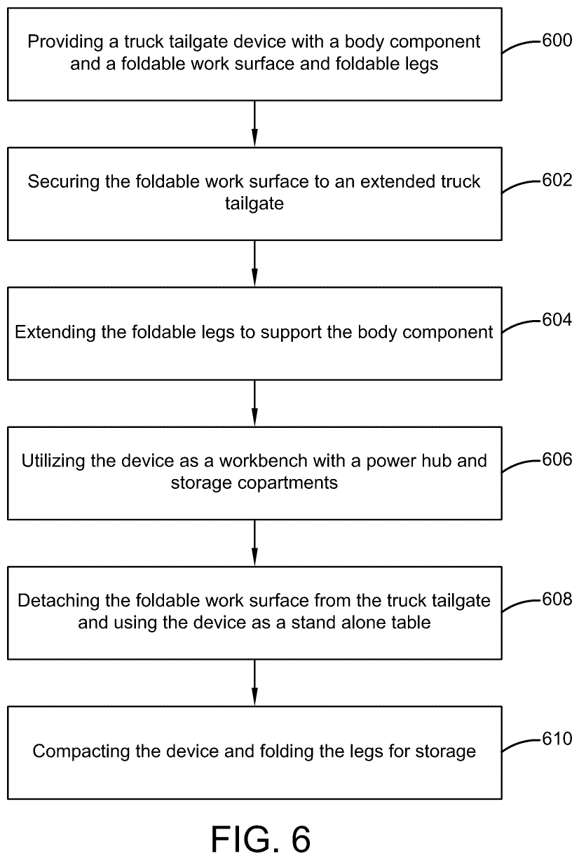

FIG. 6 illustrates a flowchart of the method of adding useability to a truck tailgate. The method includes the steps of at 600, providing a truck tailgate workbench device with a body component and a foldable work surface, and foldable legs. The method comprises at 602, securing the foldable work surface to an extended truck tailgate. The method also comprises at 604, extending the foldable legs to support the body component. Further, the method comprises at 606, utilizing the device as a workbench with a power hub and storage compartments. The method also comprises at 608, detaching the foldable work surface from the truck tailgate and using the device as a standalone table. Finally, the method comprises at 610, compacting the device and folding the legs for storage.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “truck tailgate workbench device”, “tailgate device”, “workbench device”, and “device” are interchangeable and refer to the truck tailgate workbench device 100 of the present invention.

Notwithstanding the foregoing, the truck tailgate workbench device 100 of the present invention can be of any suitable size and configuration as is known in the art without affecting the overall concept of the invention, provided that it accomplishes the above-stated objectives. One of ordinary skill in the art will appreciate that the truck tailgate workbench device 100 as shown in FIGS. 1-6 is for illustrative purposes only, and that many other sizes and shapes of the truck tailgate workbench device 100 are well within the scope of the present disclosure. Although the dimensions of the truck tailgate workbench device 100 are important design parameters for user convenience, the truck tailgate workbench device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A truck tailgate workbench device that provides a user with a foldable workbench extension for a truck tailgate, the truck tailgate workbench device comprising:
a body component;
a plurality of legs; and
a foldable work surface;
wherein the body component is configured in a rectangular shape to match a truck tailgate;
wherein the plurality of legs are secured to the body component for support next to the truck tailgate or as a standalone table configuration; and
further wherein a top of the body component comprises the foldable work surface, which can be secured to the truck tailgate or be folded over on itself for the standalone table configuration.

2. The truck tailgate workbench device of claim 1, wherein for storage or transport purposes, the plurality of legs can be folded up compact and secured within a bottom of the body component, with the body component then secured to the truck tailgate.

3. The truck tailgate workbench device of claim 2, wherein as the truck tailgate opens and closes, the truck tailgate workbench device remains compact and mounted to the truck tailgate, until needed for use.

4. The truck tailgate workbench device of claim 3, wherein the body component comprises opposing side edges, opposing front and rear edges, a top surface and a bottom surface.

5. The truck tailgate workbench device of claim 4, wherein the plurality of legs are secured to the bottom surface of the body component and positioned in each corner.

6. The truck tailgate workbench device of claim 5, wherein the plurality of legs are foldable and able to be collapsed for storage, and also telescoping, allowing the plurality of legs to extend and retract, as needed.

7. The truck tailgate workbench device of claim 6, wherein an additional set of legs can be secured to corners of the extended work surface, when the foldable work surface is extended out for use with the standalone table configuration.

8. The truck tailgate workbench device of claim 7, wherein the foldable work surface comprises two rectangular panel components that are secured at their sides via several hinges, wherein the hinges allow the two rectangular panel components to be extended for a large work surface or folded in for a smaller, more compact work surface.

9. The truck tailgate workbench device of claim 8, wherein the two rectangular panel components comprise a rhino lining surface on top and bottom surfaces.

10. The truck tailgate workbench device of claim 9, wherein the two rectangular panel components comprise at least one measurement imprint positioned on an edge.

11. The truck tailgate workbench device of claim 10, wherein the body component comprises at least one power outlet hub and detachable cord, integrated into the body component side edges.

12. The truck tailgate workbench device of claim 11, wherein the body component comprises at least one storage compartment for tools and materials.

13. A truck tailgate workbench device that provides a user with a foldable workbench extension for a truck tailgate, the truck tailgate workbench device comprising:
a body component comprising opposing side edges, opposing front and rear edges, a top surface and a bottom surface;
a plurality of legs; and
a foldable work surface comprising two rectangular panel components that are secured at their sides via several hinges, wherein the hinges allow the two rectangular panel components to be extended for a large work surface or folded in for a smaller, more compact work surface;
wherein the body component is configured in a rectangular shape to match a truck tailgate;
wherein the plurality of legs are secured to the bottom surface of the body component and positioned in each corner for support next to the truck tailgate or as a standalone table configuration;
wherein the plurality of legs are foldable and able to be collapsed for storage, and also telescoping, allowing the plurality of legs to extend and retract, as needed;
wherein an additional set of legs can be secured to corners of the extended work surface, when the foldable work surface is extended out for use with the standalone table configuration;
wherein a top of the body component comprises the foldable work surface, which can be secured to the truck tailgate or be folded outward for the standalone table configuration;
wherein for storage or transport purposes, the plurality of legs can be folded up compact and secured within a bottom of the body component, with the body component then secured to the truck tailgate;
wherein the two rectangular panel components comprise a rhino lining surface on top and bottom surfaces and at least one measurement imprint positioned on an edge;
wherein the body component comprises at least one power outlet hub and detachable cord, integrated into the body component side edges; and
further wherein the body component comprises at least one storage compartment for tools and materials.

14. The truck tailgate workbench device of claim 13, wherein the truck tailgate workbench device can be compacted for storage and stored in a truck bed and not attached to the tailgate.

15. The truck tailgate workbench device of claim 13 further comprising a plurality of indicia.

16. The truck tailgate workbench device of claim 13, wherein the truck tailgate workbench device can be configured as a standalone table, secured to an extended truck tailgate, or a standalone table with an extended foldable work surface.

17. The truck tailgate workbench device of claim 13, wherein the body component further comprises additional accessories, such as a light source, a pencil holder, receptacles for holding drinks, and/or a magnetic tray for holding screws, nails, or drill bits.

18. The truck tailgate workbench device of claim 13, wherein the truck tailgate workbench device is offered as an OEM feature on newly manufactured pickup trucks.

19. The truck tailgate workbench device of claim 13, wherein the truck tailgate workbench device is available as an after-market addition.

20. A method of adding useability to a truck tailgate, the method comprising the following steps:
providing a truck tailgate workbench device with a body component and a foldable work surface and foldable legs;
securing the foldable work surface to an extended truck tailgate;
extending the foldable legs to support the body component;
utilizing the device as a workbench with a power hub and storage compartments;
detaching the foldable work surface from the truck tailgate and using the device as a folded or unfolded standalone table; and
compacting the device and folding the legs for storage.
